(19) United States
(12) Patent Application Publication
(10) Pub. No.: US 2005/0193539 A1
(43) Pub. Date: Sep. 8, 2005

(54) Molding remover system

(76) Inventor: Robert D. Payne, Virginia Beach, VA (US)

Correspondence Address: Michael S. Neustel, Suite No. 4, 2534 South University Drive, Fargo, ND, 58103, US

(21) Appl. No.: 10/792,081

(22) Filed: Mar. 2, 2004

(51) Int. Cl. B60J 5/04

(52) U.S. Cl. 29/235

(57) ABSTRACT

A molding remover system for efficiently removing door molding from a vehicle without requiring removal of the door glass. The molding remover system includes a handle and a shaft member extending from the handle. The shaft member has an engaging portion that extends toward the handle. The engaging portion is formed for engaging a retainer clip attaching a window molding to a door frame.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to vehicle molding removers and more specifically it relates to a molding remover system for efficiently removing door molding from a vehicle without requiring removal of the door glass.

2. Description of the Related Art

Window molding for automobiles typically has clips that have a resilient jaw member. The jaw member has a lower hook that engages the lower edge of an extended member within the door frame. FIGS. 4 through 9 illustrate an exemplary window molding attached within a door frame of an automobile. There is a need for an efficient system that allows for the removal of window molding without requiring removal of the door glass.

### BRIEF SUMMARY OF THE INVENTION

In view of the foregoing disadvantages inherent in the known types of molding removers now present in the prior art, the present invention provides a new molding remover system construction wherein the same can be utilized for efficiently removing door molding from a vehicle.

The general purpose of the present invention, which will be described subsequently in greater detail, is to provide a new molding remover system that has many of the advantages of the molding removers mentioned heretofore and many novel features that result in a new molding remover system which is not anticipated, rendered obvious, suggested, or even implied by any of the prior art molding removers, either alone or in any combination thereof.

To attain this, the present invention generally comprises a handle and a shaft member extending from the handle. The shaft member has an engaging portion that extends toward the handle. The engaging portion is formed for engaging a retainer clip attaching a window molding to a door frame.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a molding remover system that will overcome the shortcomings of the prior art devices.

A second object is to provide a molding remover system for efficiently removing door molding from a vehicle without requiring removal of the door glass.

Another object is to provide a molding remover system that does not damage the molding or clip structure.

An additional object is to provide a molding remover system that can be utilized upon various models of automobiles.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention in a first position.

FIG. 2 is an upper perspective view of the present invention in a second position.

FIG. 3 is an upper perspective view of the present invention in a third position.

FIG. 4 is an end view of the present invention.

FIG. 5a is a side view of the present invention being inserted between a window molding and the door glass.

FIG. 5b is a side view of the present invention being rotated thereby causing the hook member to be removed from the door frame.

FIG. 5c is a side view of the present invention lifting the removed window molding from the door frame.

FIG. 6a is an upper perspective view of the present invention being inserted between the door glass and the window molding.

FIG. 6b is an upper perspective view of the present invention being lifted for removing the window molding.

FIG. 6c is an upper perspective view of the present invention being slid between the door glass and the window molding.

FIG. 7 is an upper perspective view of an alternative embodiment of the present invention.

FIG. 8 is a side view of the alternative embodiment.

FIG. 9 is an end view of the alternative embodiment.

### DETAILED DESCRIPTION OF THE INVENTION

A. Overview of Invention

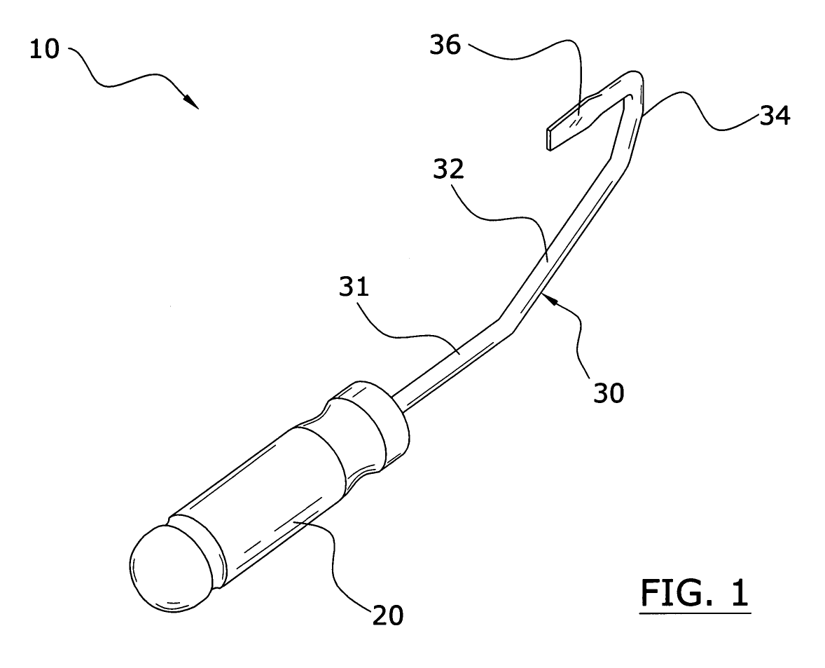

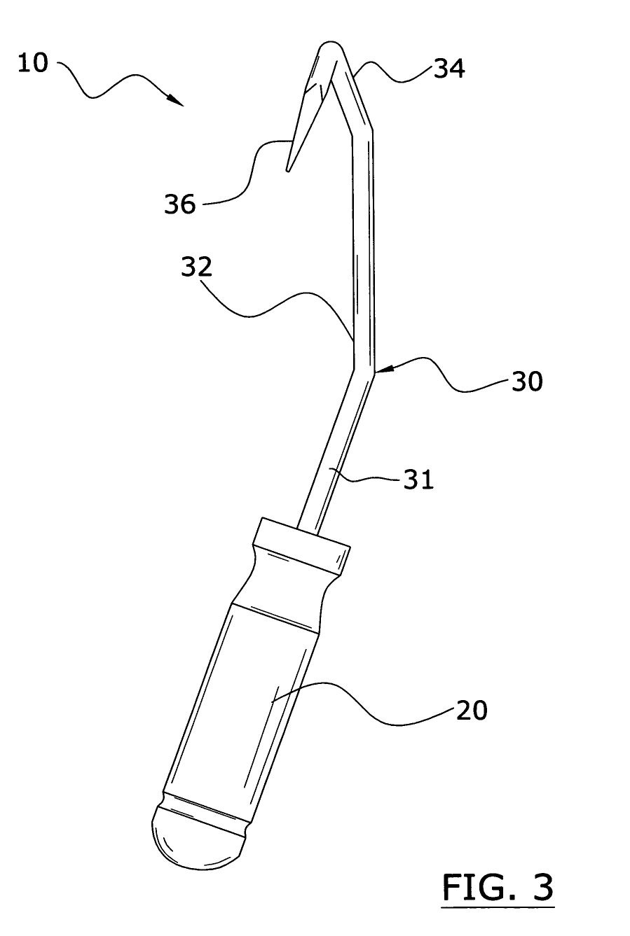

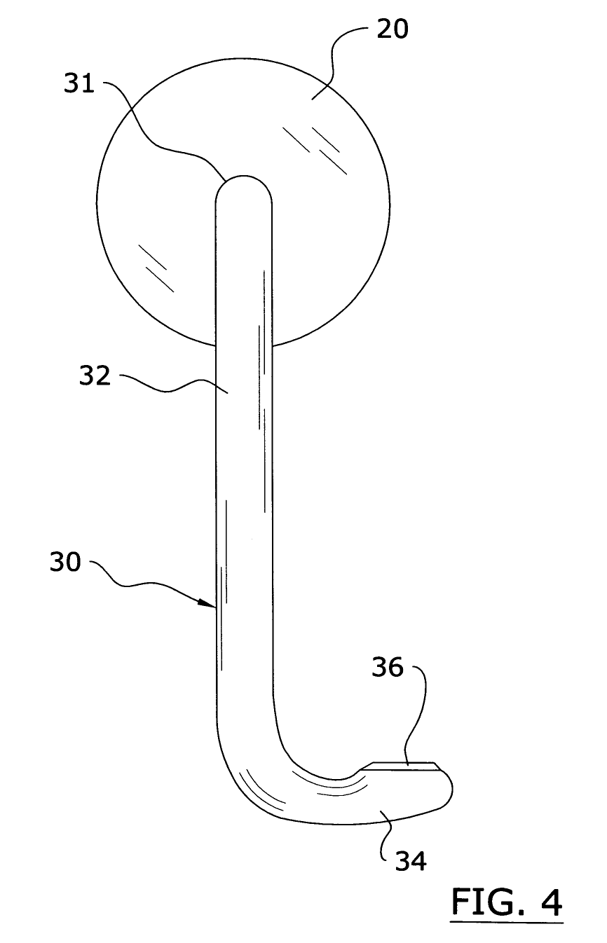

Turning now descriptively to the drawings, in which similar reference characters denote similar elements throughout the several views, FIGS. 1 through 8 illustrate a molding remover system 10, which comprises a handle 20 and a shaft member 30 extending from the handle 20. The shaft member 30 has an engaging portion 36 that extends toward the handle 20. The engaging portion 36 is formed for engaging a retainer clip 18 attaching a window molding to a door frame.

B. Handle

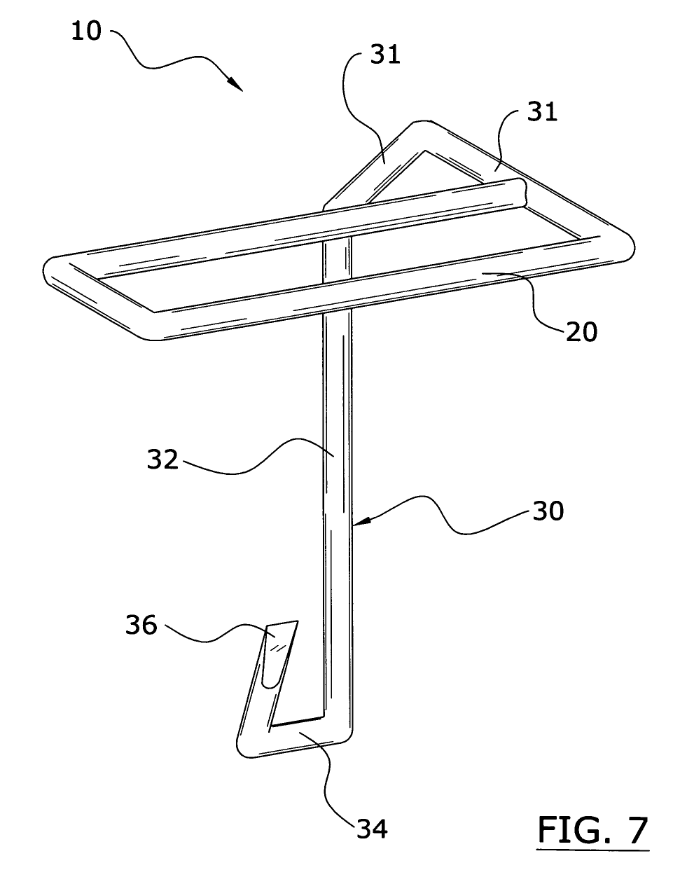

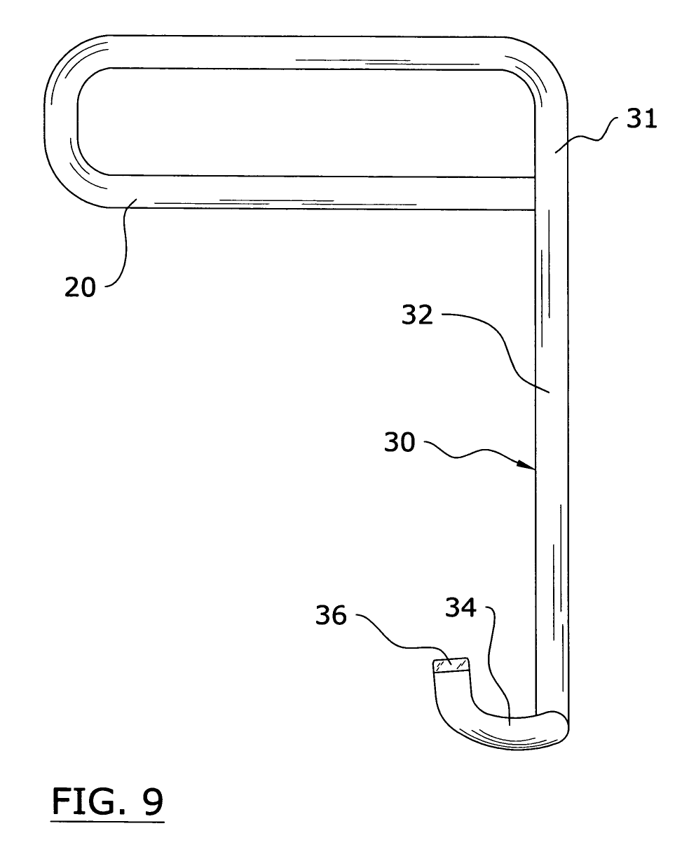

FIGS. 1 through 9 illustrate an exemplary handle 20 that may be utilized with the present invention. The handle 20 illustrated in FIGS. 1 through 6c is comprised of an elongate closed structure similar to that utilized with a screwdriver that the user grasps. The handle 20 illustrated in FIGS. 7 through 9 is comprised of an open rectangular structure with a center opening for the user to extend their hand through. It can be appreciated that various other structures and designs may be utilized to construct the handle 20.

C. Shaft Member

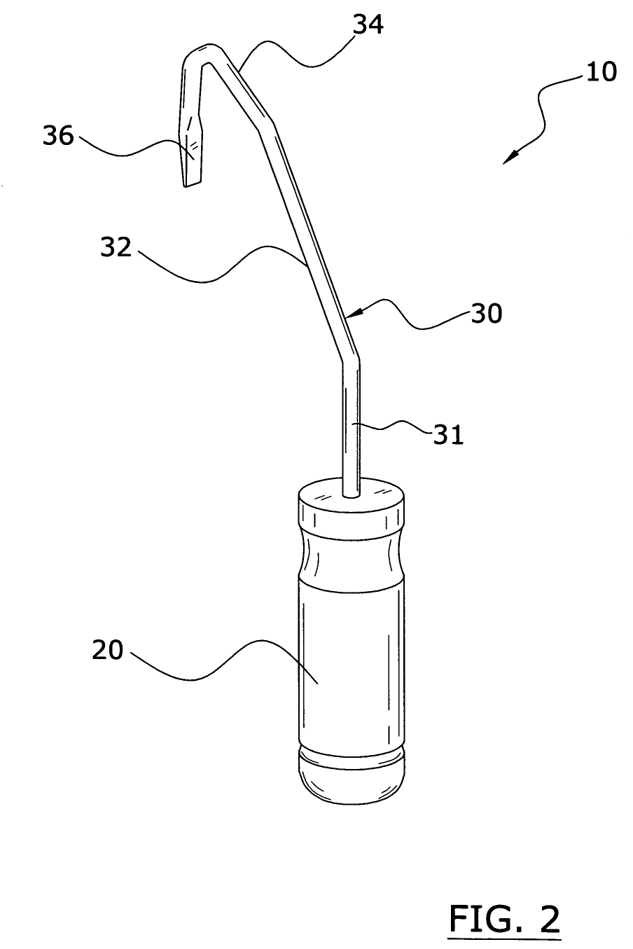

A shaft member 30 extends from the handle 20 as shown in FIGS. 1 through 9 of the drawings. The shaft member 30 includes a distal portion that is angled toward the handle 20 as best illustrated in FIGS. 2, 3 and 8 of the drawings. The distal portion of the shaft member 30 includes an engaging portion 36 for selectively engaging a retainer clip 18 as shown in FIGS. 1, 2, 3 and 7 of the drawings.

FIGS. 1 through 6c illustrate a first embodiment of the present invention wherein the shaft member 30 is comprised of a first segment 31 extending from the handle 20, a second segment 32 extending from the first segment 31 at a first angle, and a third segment 34 extending from the second segment 32 at a second angle. The engaging portion 36 extends from the third segment 34 at a third angle as best illustrated in FIGS. 1 and 2 of the drawings. The first angle and the second angle may be comprised of an angle greater than one hundred degrees. The third angle may be comprised of an angle less than ninety degrees as best illustrated in FIGS. 1 and 2 of the drawings. The engaging portion 36 may be substantially parallel to the first segment 31 and directed toward the handle 20 as shown in FIGS. 1 and 2 of the drawings. The engaging portion 36 may be flat and tapered with a broad structure as further shown in FIGS. 1 and 2 of the drawings.

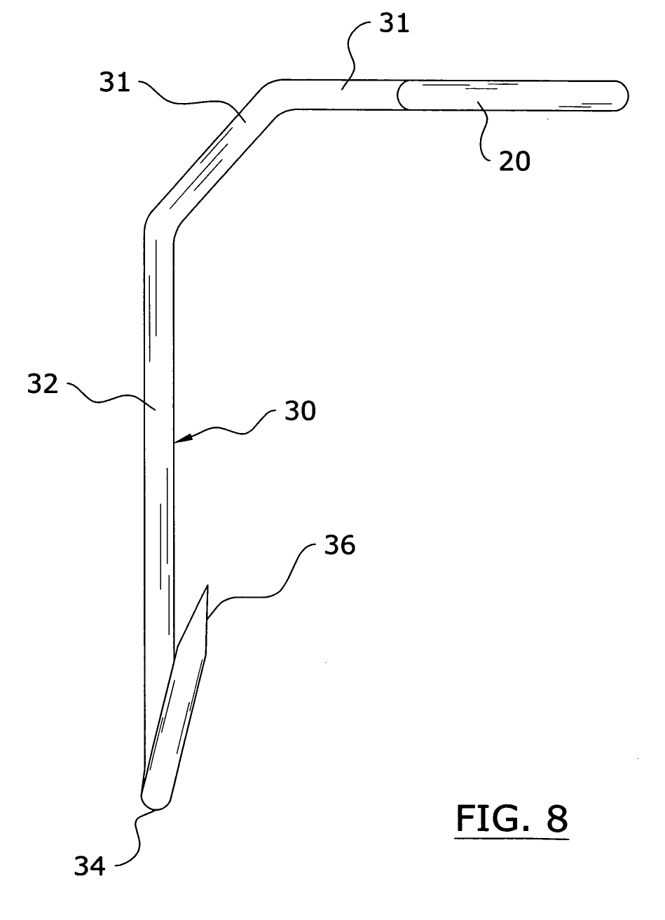

FIGS. 7 through 9 of the drawings illustrate a second embodiment of the present invention. The second embodiment has an extended portion 31′ that extends outwardly from the handle 20 as best illustrated in FIG. 7 of the drawings. In the alternative embodiment, the third segment 34 is approximately ninety degrees with respect to the second segment 32 as best shown in FIG. 7 of the drawings. Also, the engaging portion 36 is approximately ninety degrees with respect to the second segment 32 as best shown in FIG. 7 of the drawings. The engaging portion 36 extends towards the handle 20 at an angle with respect to the second segment 32 as shown in FIG. 8 of the drawings.

D. Operation of Invention—First Embodiment

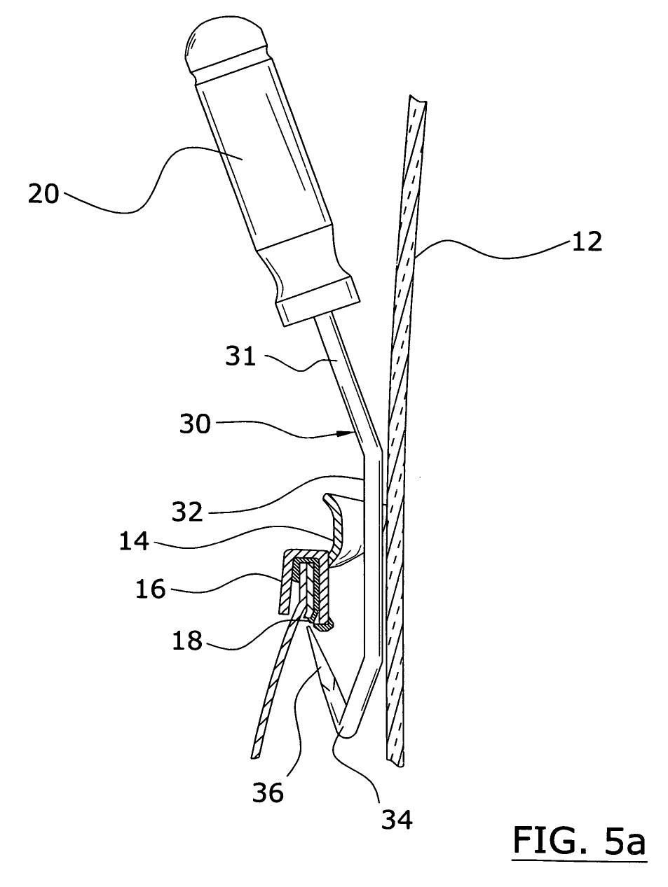

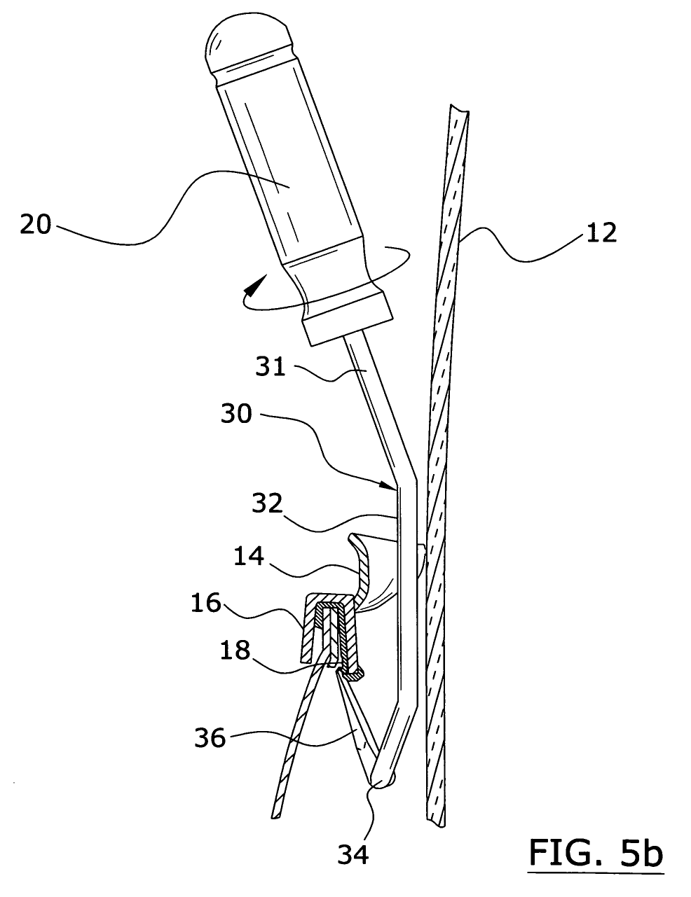

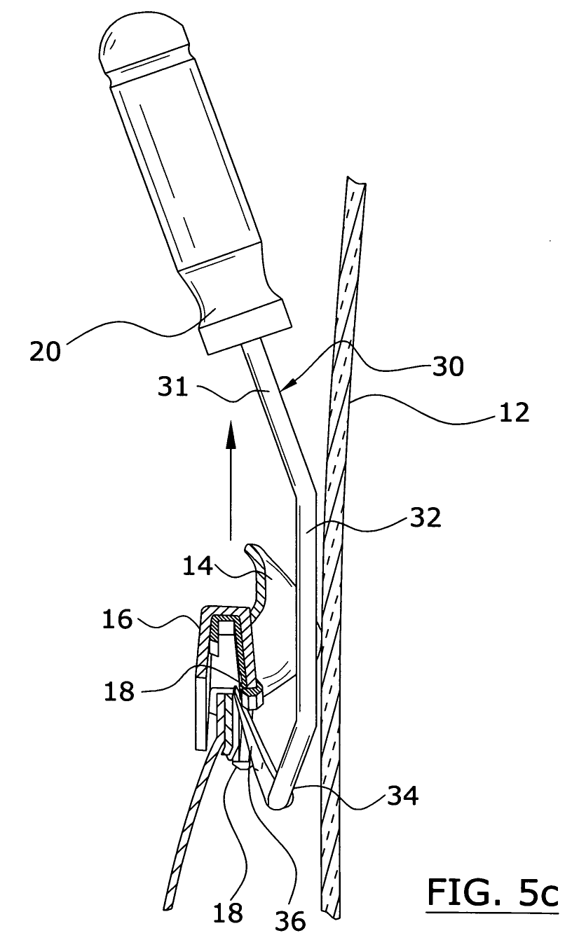

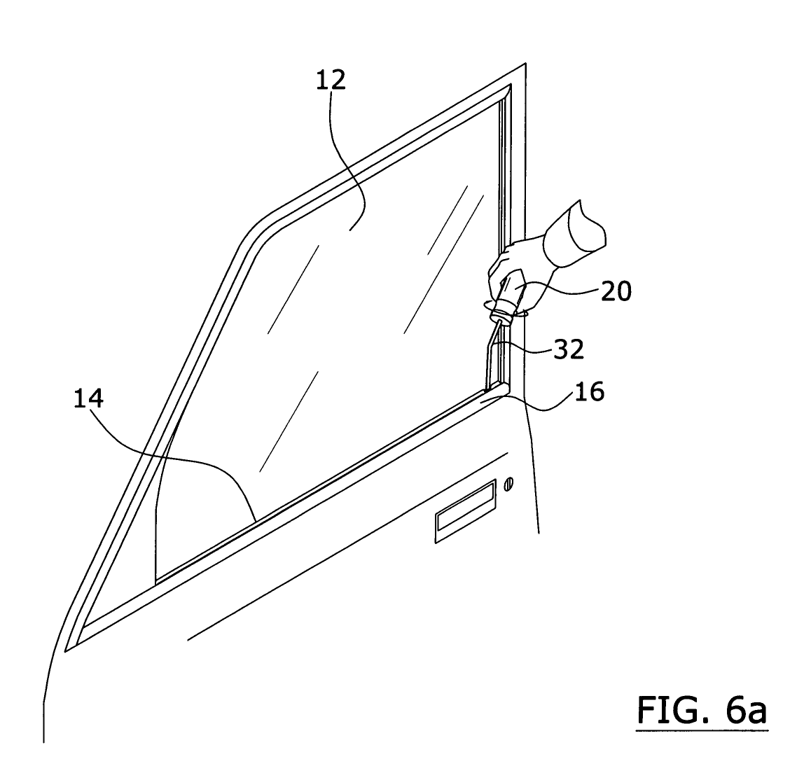

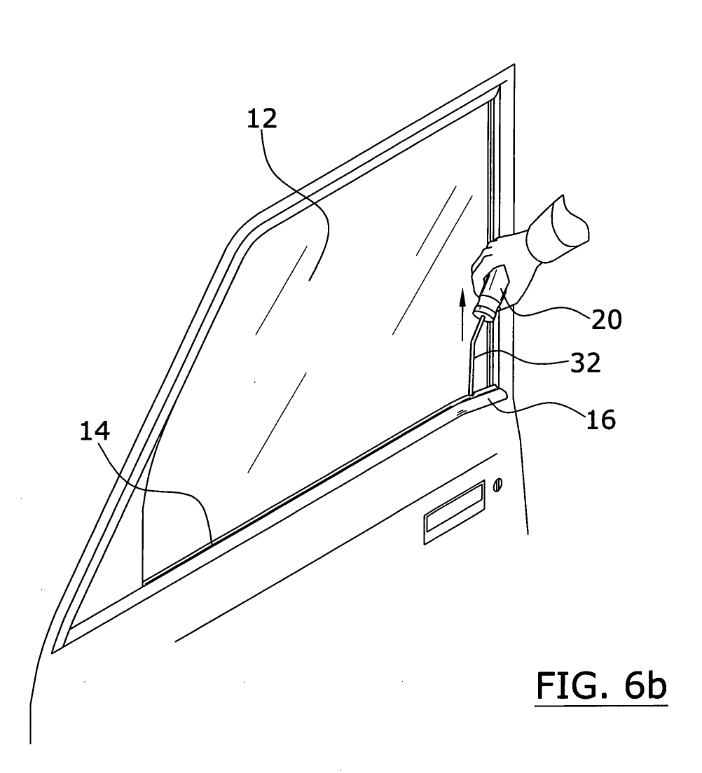

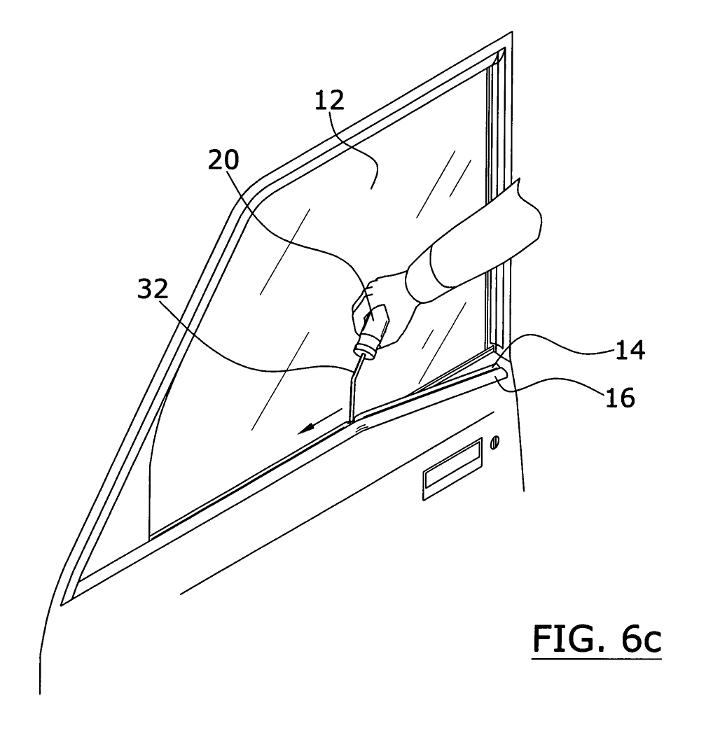

In use, the user inserts the engaging portion 36 between the molding belt 14 of the window molding and the door glass 12. The user continues to insert the shaft member 30 downwardly within the door of the automobile as best illustrated in FIG. 6a of the drawings. The user then lifts the engaging portion 36 upwardly to engage a retainer clip 18 attached to the window molding as shown in FIG. 5a of the drawings. The user then rotates the handle 20 thereby causing the engaging portion 36 to apply an outward force to the retainer clip 18 thereby forcing the retainer clip 18 from the upper lip of the door as shown in FIG. 5b of the drawings. The user then lifts upwardly upon the engaging portion 36 thereby causing the molding frame 16 to be lifted from the door frame. This process continues until the window molding is completely removed.

E. Operation of Invention—Second Embodiment

In use, the user inserts the engaging portion 36 between the molding belt 14 of the window molding and the door glass 12. The user continues to insert the shaft member 30 downwardly within the door of the automobile similar to the first embodiment. The user then lifts the engaging portion 36 upwardly to engage a retainer clip 18 attached to the window molding. The user continues to lift upon the engaging portion 36 thereby causing the engaging portion 36 to apply an outward force to the retainer clip 18 thereby forcing the retainer clip 18 from the upper lip of the door. The user continues to lift upwardly upon the engaging portion 36 thereby causing the molding frame 16 to be lifted from the door frame. This process continues until the window molding is completely removed.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A molding remover system, comprising:
a handle; and
a shaft member extending from said handle, wherein said shaft member includes a distal portion that is angled toward said handle and wherein said distal portion includes an engaging portion for selectively engaging a retainer clip.

2. The molding remover system of claim 1, wherein said shaft member is comprised of:
a first segment extending from said handle;
a second segment extending from said first segment at a first angle; and
a third segment extending from said second segment at a second angle, wherein said engaging portion extends from said third segment at a third angle.

3. The molding remover system of claim 2, wherein said first angle is comprised of an angle greater than one hundred degrees.

4. The molding remover system of claim 2, wherein said second angle is comprised of an angle greater than one hundred degrees.

5. The molding remover system of claim 2, wherein said third angle is comprised of an angle less than ninety degrees.

6. The molding remover system of claim 2, wherein said engaging portion is substantially parallel to said first segment.

7. The molding remover system of claim 1, wherein said engaging portion is directed towards said handle.

8. The molding remover system of claim 1, wherein said engaging portion is tapered.

9. The molding remover system of claim 1, wherein said engaging portion is flat.

10. The molding remover system of claim 9, wherein said engaging portion has a broad structure.

11. The molding remover system of claim 1, wherein said shaft member is comprised of:
an extended portion extending from said handle;
a first segment extending from said extended portion;
a second segment extending from said first segment at a first angle; and
a third segment extending from said second segment at a second angle, wherein said engaging portion extends from said third segment at a third angle.

12. The molding remover system of claim 11, wherein said first angle is comprised of an angle greater than one hundred degrees.

13. The molding remover system of claim 11, wherein said second angle is comprised of approximately ninety degrees.

14. The molding remover system of claim 11, wherein said third angle is comprised of approximately ninety degrees.

15. The molding remover system of claim 11, wherein said engaging portion is substantially parallel to said first segment.

16. The molding remover system of claim 11, wherein said engaging portion is directed towards said handle.

17. The molding remover system of claim 11, wherein said engaging portion is tapered.

18. The molding remover system of claim 11, wherein said engaging portion is flat.

19. The molding remover system of claim 18, wherein said engaging portion has a broad structure.

20. A molding remover system, comprising:
a handle; and
a shaft member extending from said handle, wherein said shaft member includes a distal portion that is angled toward said handle and wherein said distal portion includes an engaging portion for selectively engaging a retainer clip;
wherein said shaft member is comprised of:
a first segment extending from said handle;
a second segment extending from said first segment at a first angle; and
a third segment extending from said second segment at a second angle,
wherein said engaging portion extends from said third segment at a third angle;
wherein said first angle is comprised of an angle greater than one hundred degrees;
wherein said second angle is comprised of an angle greater than one hundred degrees;
wherein said third angle is comprised of an angle less than ninety degrees;
wherein said engaging portion is substantially parallel to said first segment;
wherein said engaging portion is directed towards said handle;
wherein said engaging portion is flat and tapered;
wherein said engaging portion has a broad structure.
